(19) United States
(12) Patent Application Publication
(10) Pub. No.: US 2020/0235375 A1
(43) Pub. Date: Jul. 23, 2020

(54) LIQUID COMPOSITION, ELECTRODE AND METHOD OF MANUFACTURING ELECTRODE, AND ELECTROCHEMICAL ELEMENT AND METHOD OF MANUFACTURING ELECTROCHEMICAL ELEMENT

(71) Applicants: Satoshi NAKAJIMA, Tokyo (JP); Hiromichi KURIYAMA, Kanagawa (JP); Shigeo TAKEUCHI, Kanagawa (JP); Eiko HIBINO, Kanagawa (JP); Toru USHIROGOCHI, Kanagawa (JP)

(72) Inventors: Satoshi NAKAJIMA, Tokyo (JP); Hiromichi KURIYAMA, Kanagawa (JP); Shigeo TAKEUCHI, Kanagawa (JP); Eiko HIBINO, Kanagawa (JP); Toru USHIROGOCHI, Kanagawa (JP)

(73) Assignee: Ricoh Company, Ltd., Tokyo (JP)

(21) Appl. No.: 16/747,893

(22) Filed: Jan. 21, 2020

(30) Foreign Application Priority Data
Jan. 22, 2019 (JP) 2019-008762
Nov. 15, 2019 (JP) 2019-207234

(51) Int. Cl. H01M 4/08; H01M 4/36; H01M 4/62

(52) U.S. Cl. CPC H01M 4/08; H01M 4/622; H01M 4/366; H01M 4/364

(57) ABSTRACT

A liquid composition is used for forming an electrode mixture layer included in an electrochemical element. The liquid composition includes a dispersion medium; an electrode material; and a compound configured to bind the electrode material, and to bind the electrode material to an electrode substrate. The liquid composition has a viscosity such that the liquid composition can be discharged from an inkjet head.

### CROSS-REFERENCE TO RELATED APPLICATION

The present application is based on and claims priority under 35 U.S.C. § 119 to Japanese Patent Application No. 2019-008762, filed on Jan. 22, 2019, and Japanese Patent Application No. 2019-207234, filed on Nov. 15, 2019, the contents of which are incorporated herein by reference in their entirety.

### BACKGROUND OF THE INVENTION

### 1. Field of the Invention

The present invention relates to a liquid composition, an electrode and a method of manufacturing the electrode, and an electrochemical element and a method of manufacturing the electrochemical element.

### 2. Description of the Related Art

Currently, there is an increasing need for thin batteries to be installed in various wearable devices and medical patches. Primary batteries are also used for disposable medical patches. Currently, the mainstream primary batteries are coin-shaped batteries and cylindrical-shaped batteries. Thin batteries used for wearable devices and medical applications are desired to be flexible and to have freedom in shape, etc.

In the related art, as a method of manufacturing an electrode of an electrochemical element of a primary battery, etc., there is known a method of forming an electrode mixture layer on an electrode substrate, by applying a printing coating material using a die coater, a comma coater, a reverse roll coater, and the like. Here, an electrochemical element has a structure in which a positive electrode and a negative electrode are arranged so as to sandwich an insulating body, and has a function of storing electrical energy. In the printing coating material, typically, a binder is dissolved in an organic solvent or water, and has a viscosity of several thousands to several ten thousands of mPa·s at 25° C.

For example, a liquid composition including an electrode material (active material) can be used to form an electrode mixture layer on an electrode substrate by screen printing. However, when the electrode mixture layer is to be formed by screen printing, it is necessary to fabricate a screen for each shape, in order to freely form any shape by printing to meet any kind of needs. Therefore, a method of applying an electrode mixture layer on an electrode substrate using a liquid composition by an inkjet apparatus has been studied (see, for example, Patent Documents 1 and 2).

According to an inkjet apparatus, an electrochemical element can be fabricated by printing the electrode mixture layer to freely form any shape without the use of a screen. Further, the printing target is not limited to a flat surface, but printing can be performed on a curved surface or an irregular structure, and an electrochemical element that is flexible and that has freedom in shape can be fabricated. The viscosity of the liquid composition used in the inkjet apparatus is to be less than the viscosity of the printing coating material of the related art, in consideration of storage stability and discharge stability.
Patent Document 1: Japanese Patent No. 5571304
Patent Document 2: Japanese Patent No. 5913780

### SUMMARY OF THE INVENTION

According to one aspect of the present invention, there is provided a liquid composition used for forming an electrode mixture layer included in an electrochemical element, the liquid composition including a dispersion medium; an electrode material; and a compound configured to bind the electrode material, and to bind the electrode material to an electrode substrate, wherein the liquid composition has a viscosity such that the liquid composition can be discharged from an inkjet head.

### BRIEF DESCRIPTION OF THE DRAWINGS

FIG. 1 is a cross-sectional view illustrating an example of a negative electrode used in an electrochemical element according to an embodiment of the present invention;

FIG. 2 is a cross-sectional view illustrating an example of a positive electrode used in an electrochemical element according to an embodiment of the present invention;

FIG. 3 is a cross-sectional view illustrating an example of an electrode element used in an electrochemical element according to an embodiment of the present invention;

FIG. 4 is a cross-sectional view illustrating an example of an electrochemical element according to an embodiment of the present invention;

FIG. 5 is a diagram illustrating an example of a method of manufacturing the negative electrode according to an embodiment of the present invention;

FIG. 6 is a diagram illustrating an example of a circulating device for a liquid composition according to an embodiment of the present invention;

FIG. 7 is a diagram illustrating an example of another method of manufacturing the negative electrode according to an embodiment of the present invention; and

FIG. 8 is a diagram summarizing practical examples according to an embodiment of the present invention and comparative examples.

### DETAILED DESCRIPTION OF THE PREFERRED EMBODIMENTS

In order to reduce the viscosity of the liquid composition, it is considered to reduce the content of the binder. The binder is to be added to the electrode material by a fixed amount, in order to bind the electrode material to the electrode substrate and to bind electrode material.

That is, by reducing the content of the binder in the liquid composition, the binding between the electrode material and the electrode substrate and between electrode materials, is weakened, and, therefore, the amount of the electrode material that can be included in the liquid composition is reduced. When the amount of the electrode material in the liquid composition is small, it may not be possible to obtain sufficient battery properties, and, therefore, it is difficult to reduce the binder content. Accordingly, it has not been possible to realize a liquid composition having excellent storage stability and discharge stability.

A problem to be addressed by an embodiment of the present invention is to provide a liquid composition that has excellent storage stability and discharge stability, and that can be used to form an electrode mixture layer included in an electrochemical element.

Hereinafter, an embodiment for carrying out the present invention will be described with reference to the drawings. In the drawings, the same elements are denoted by the same reference numerals and overlapping descriptions may be omitted.

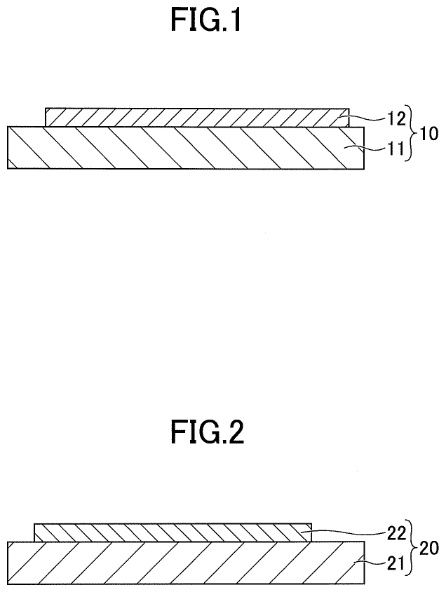

FIG. 1 is a cross-sectional view illustrating an example of a negative electrode used for an electrochemical element according to the present embodiment. An electrochemical element is a structure in which a positive electrode and a negative electrode are arranged with an insulating body sandwiched therebetween, and has a function of storing electrical energy.

Referring to FIG. 1, a negative electrode 10 has a structure including a negative electrode substrate 11 and a negative electrode mixture layer 12 formed on the negative electrode substrate 11. The shape of the negative electrode 10 is not particularly limited, and may be appropriately selected depending on the purpose. Examples include flat plates and the like.

FIG. 2 is a cross-sectional view illustrating an example of a positive electrode used for an electrochemical element according to the present embodiment. Referring to FIG. 2, a positive electrode 20 has a structure including a positive electrode substrate 21 and a positive electrode mixture layer 22 formed on the positive electrode substrate 21. The shape of the positive electrode 20 is not particularly limited, and may be appropriately selected depending on the purpose. Examples include flat plates and the like.

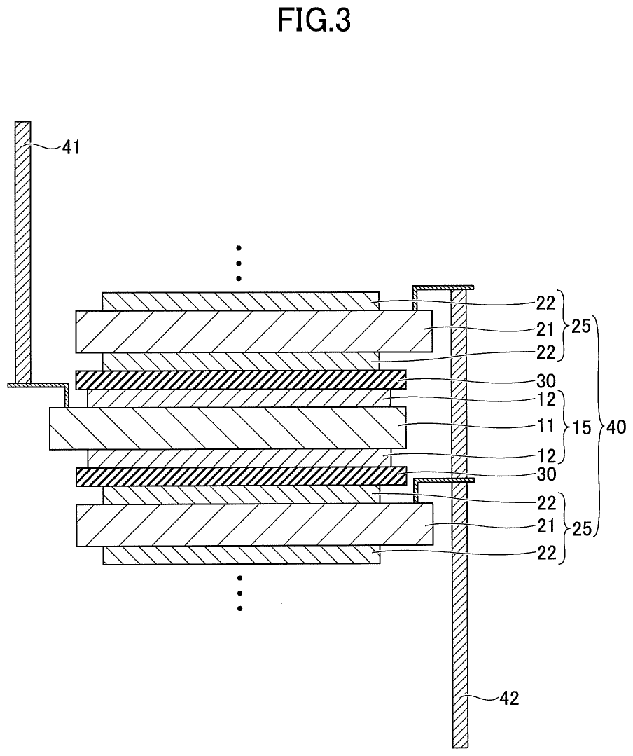

FIG. 3 is a cross-sectional view illustrating an example of an electrode element used for an electrochemical element according to the present embodiment. Referring to FIG. 3, an electrode element 40 includes a structure in which a negative electrode 15 and a positive electrode 25 are stacked in an insulated state from each other via a separator 30. In the electrode element 40, the positive electrode 25 is stacked on both sides of the negative electrode 15. A negative electrode extraction line 41 is connected to the negative electrode substrate 11. A positive electrode extraction line 42 is connected to the positive electrode substrate 21.

The negative electrode 15 differs from the negative electrode 10 (see FIG. 1) in that the negative electrode mixture layer 12 is formed on both sides of the negative electrode substrate 11, and other points are the same as the negative electrode 10. The positive electrode 25 differs from the positive electrode 20 (see FIG. 2) in that the positive electrode mixture layer 22 is formed on both sides of the positive electrode substrate 21, and other points are the same as the positive electrode 20.

Note that in the electrode element 40, the number of stacked layers of the negative electrode 15 and the positive electrode 25 may be determined to be any number. That is, in FIG. 3, a total of three layers including one negative electrode 15 and two positive electrodes 25 are illustrated; however, the number of stacked layers is not limited thereto, and many more negative electrodes 15 and positive electrodes 25 may be stacked. In this case, the number of the negative electrodes 15 and the number of the positive electrodes 25 may be the same.

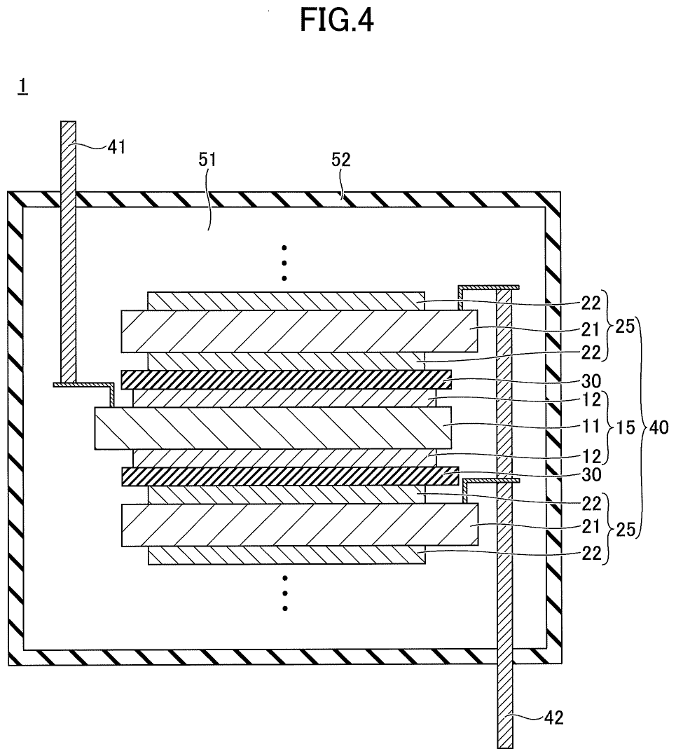

FIG. 4 is a cross-sectional view illustrating an example of an electrochemical element according to the present embodiment. Referring to FIG. 4, an electrochemical element 1 has a structure in which an electrolyte layer 51 is formed by injecting an aqueous electrolyte solution or a non-aqueous electrolyte solution into the electrode element 40 and then sealing this with an outer sheath 52. In the electrochemical element 1, the negative electrode extraction line 41 and the positive electrode extraction line 42 are drawn out of the outer sheath 52. The electrochemical element 1 may include other members according to need. The electrochemical element 1 is not particularly limited and may be appropriately selected depending on the purpose; examples include an aqueous electrolyte battery, a non-aqueous electrolyte battery, an aqueous electrolyte capacitor, a non-aqueous electrolyte capacitor, and the like.

The shape of the electrochemical element 1 is not particularly limited. The shape of the electrochemical element 1 may be appropriately selected from among a variety of commonly adopted shapes according to the purpose. Examples include a laminate type, a cylinder type in which a sheet electrode and a separator are spiral, a cylinder type having an inside out structure in which a pellet electrode and a separator are combined, a coin type in which a pellet electrode and a separator are stacked, and the like.

Hereinafter, the electrochemical element 1 will be described in detail. Note that the negative electrode and the positive electrode may be collectively referred to as an electrode, the negative electrode substrate and the positive electrode substrate may be collectively referred to as an electrode substrate, the negative electrode mixture layer and the positive electrode mixture layer may be collectively referred to as an electrode mixture layer, and a positive electrode material and a negative electrode material may be collectively referred to as an electrode material.

### <Electrode>

### <<Electrode Substrate>>

The material forming the electrode substrate (electrode current collector) is not particularly limited as long as the material is electrically conductive and is stable with respect to the applied potential.

### —Negative Electrode Substrate

The material, shape, size, and structure of the negative electrode substrate 11 are not particularly limited, and may be appropriately selected depending on the purpose, and the negative electrode substrate 11 may have a structure having irregularities on the surface.

The material of the negative electrode substrate 11 is not particularly limited as long as the negative electrode substrate 11 is formed of an electrically conductive material, and the material may be appropriately selected according to the purpose. Examples include stainless steel, nickel, aluminum, copper and the like.

### —Positive Electrode Substrate

The material, shape, size, and structure of the positive electrode substrate 21 are not particularly limited, and may be appropriately selected depending on the purpose, and the positive electrode substrate 21 may have a structure having irregularities on the surface.

The material of the positive electrode substrate 21 is not particularly limited as long as the positive electrode substrate 21 is formed of an electrically conductive material and is stable with respect to the applied potential, and the material may be appropriately selected according to the purpose. Examples include stainless steel, nickel, aluminum, titanium, tantalum and the like.

### <<Electrode Mixture Layer>>

The negative electrode mixture layer 12 and/or the positive electrode mixture layer 22 can be formed by applying a liquid composition according to the present embodiment onto an electrode substrate by using an inkjet printing apparatus and curing the liquid composition. The liquid composition according to the present embodiment can be cured by a method such as applying heat, applying light, ultraviolet irradiation, and the like.

### —Liquid Composition

The liquid composition according to the present embodiment is a liquid composition used for forming the electrode mixture layer included in the electrochemical element; and the liquid composition includes a dispersion medium, an electrode material, and a binder. A binder is a compound capable of binding an electrode material and of binding the electrode material to the electrode substrate.

The content of the active material (electrode material) in the liquid composition according to the present embodiment is preferably 20% by mass or more, and further preferably 25% by mass or more. If the content of active material in the liquid composition according to the present embodiment is 20% by mass or more, when the electrode mixture layer is formed on the substrate at a predetermined resolution, it is possible to form the electrode mixture layer including more electric materials, thereby improving the capacity of the non-aqueous power storage element. Further, the amount of the dispersion medium in the liquid composition can be relatively small, which is advantageous in terms of drying the liquid composition.

It is preferable that the content of the active material in the liquid composition is 50% by mass or less. When the content of the active material in the liquid composition is greater than 50% by mass, the viscosity increases and the discharge stability of the liquid composition decreases.

The viscosity of the liquid composition is to be a viscosity at which the liquid composition can be discharged from an inkjet head, and the viscosity at 25° C. is preferably 200 mPa·s or less and even more preferably 30 mPa·s or less. When the viscosity of the liquid composition at 25° C. is 200 mPa·s or less, the granularity distribution of the liquid composition is unlikely to change, and, therefore, the discharging performance is stabilized. Further, when the viscosity of the liquid composition at 25° C. is 30 mPa·s or less, the granularity distribution of the liquid composition is even more unlikely to change, and, therefore, the discharging performance is stabilized even more. Further, the viscosity of the liquid composition at 25° C. is preferably greater than or equal to 10 mPa·s. When the viscosity of the liquid composition at 25° C. is less than 10 mPa·s, it is difficult to discharge the liquid composition as liquid droplets, which makes it difficult to control the discharge amount.

The electrode material is to have a maximum particle size that is smaller than the inkjet head nozzle diameter. The inkjet head nozzle diameter is approximately 36 μm to 40 μm. The average particle size is preferably 3 μm or less, and more preferably 1 μm or less. When the average particle size of the electrode material is 3 μm or less, the discharge stability and sedimentation resistance of the liquid composition are improved. When the average particle size of the electrode material is 1 μm or less, the discharge stability and sedimentation resistance of the liquid composition are further improved. The average particle size of the electrode material can be measured by a granularity distribution meter using laser diffraction.

The median diameter (d10) of the electrode material is preferably 0.1 μm or more, and more preferably 0.15 μm or more. When the electrode material has a median diameter (d10) of 0.1 μm or more, the storage stability of the liquid composition is improved. When the electrode material has a median diameter (d10) of 0.15 μm or more, the storage stability of the liquid composition is further improved. The median diameter of the electrode material can be measured by a granularity distribution meter using laser diffraction.

The liquid composition according to the present embodiment may further include a conduction assisting agent, an electrode material dispersant, etc., according to need.

### —Negative Electrode Material (Active Material of Negative Electrode)—

Examples of the negative electrode material used in the liquid composition for the negative electrode mixture layer 12 include particles of zinc, nickel, iron, FeS₂, carbon, and the like. As the negative electrode material, lithium metal foil may also be used.

### —Positive Electrode Material (Active Material of Positive Electrode)

Examples of the positive electrode material used in the liquid composition for the positive electrode mixture layer 22 include MnO₂, Ag₂O, NiOOH, V₂O₅, graphite fluoride or fluorocarbon, iodine, FeS₂, CUO, CuS, iS₂, Ag₂CrO₄, MoO₃, Bi₂O₃, Bi₂Pb₂O₅, Cu₄O (PO₄)₂, and the like.

### —Dispersion Medium

The dispersion medium is not particularly limited as long as the positive electrode material or the negative electrode material can be dispersed, and examples include water, ethylene glycol, propylene glycol, trimethylene glycol, N-methyl-2-pyrrolidone, 2-pyrrolidone, cyclohexanone, butyl acetate, mesitylene, ethylene glycol monoethyl ether, ethylene glycol monobutyl ether, ethylene glycol monoethyl ether acetate, diethylene glycol monoethyl ether, diethylene glycol monobutyl ether, propylene glycol monomethyl ether, propylene glycol monoethyl ether, propylene glycol monobutyl ether, 2-n-butoxymethanol, 2-dimethyl ethanol, N,N-dimethylacetamide, dimethyl sulfoxide, and the like. Note that the dispersion medium may be used alone or two or more kinds may be used in combination.

### —Conduction Assisting Agent

The conduction assisting agent may be complexed with the positive electrode material or the negative electrode material in advance, or may be added when preparing the liquid composition.

As the conduction assisting agent, for example, a conductive carbon black formed by a furnace method, an acetylene method, a gasification method, and the like, and a carbon material such as carbon nanofibers, carbon nanotubes, graphene, graphite particles, and the like may be used.

As the conduction assisting agent other than carbon materials, for example, metal particles, such as aluminum, or metal fibers may be used.

The mass ratio of the conduction assisting agent with respect to the positive electrode material or the negative electrode material, is preferably 10% or less, and more preferably 8% or less. When the mass ratio of the conduction assisting agent with respect to the positive electrode material or the negative electrode material is 10% or less, the stability of the liquid composition is improved, and when the mass ratio is 8% or less, the stability of the liquid composition is further improved.

### —Electrode Material Dispersant

The electrode material dispersant is not particularly limited as long as the dispersibility of the positive electrode material or the negative electrode material in the dispersion medium and the conduction assisting agent can be improved, and examples of the electrode material dispersant include a polymer type such as a polycarboxylic acid-based type, a naphthalene sulfonate formalin condensate-based type, a polyethylene glycol, a polycarboxylic acid partial alkyl ester-based type, a polyether-based type, a polyalkylene polyamine-based type; a surface active agent type such as an alkyl sulfonate-based type, a quaternary ammonium-based type, a high alcohol alkylene oxide-based type, a multivalent alcohol ester-based type, an alkyl polyamine-based type; and an inorganic type such as a polyphosphate-based type, and the like.

### —Binder

The binder is not particularly limited as long as the binder is a compound capable of binding the negative electrode material, of binding the positive electrode material, of binding the negative electrode material to the negative electrode substrate, and of binding the positive electrode material to the positive electrode substrate. However, it is preferable to use a compound by which the viscosity of the liquid composition hardly increases, from the viewpoint of preventing the nozzle from clogging when discharging the liquid composition from an inkjet head nozzle.

In order to prevent an increase in the viscosity of the liquid composition, for example, a monomeric compound may be used as the binder. When a monomeric compound is used as the binder, the liquid composition including the monomeric compound is applied to the electrode substrate by an inkjet method, and then the monomeric compound is polymerized. Preferably, the monomer compound includes, for example, one or more kinds of molecules having a polymerizable site, and is capable of binding the electrode material and of binding the electrode material to the electrode substrate by the progress of the polymerization at 25° C.

A specific example of a method of using a monomeric compound includes, for example, applying a liquid composition to an electrode substrate, the liquid composition including, as a binder, a compound having a polymerizable site and a polymerization initiator or catalyst, wherein the compound having the polymerizable site is dissolved, followed by heating or irradiation with nonionizing radiation or ionizing radiation or infrared radiation, to form a polymer.

Preferably, the molecule having a polymerizable site is capable of forming a plurality of holes inside the electrode mixture layer, and one of the holes inside the electrode mixture layer is in communication with other holes surrounding the hole inside the electrode mixture layer, thereby extending in a three-dimensional manner. The communication between the holes allows the electrolyte to penetrate sufficiently in the electrode mixture layer, thereby allowing the ions to move smoothly.

With regard to the polymerization site of the compound having a polymerizable site, there may be one intramolecular polymerization site or the polymerization site may be polyfunctional. Note that a polyfunctional polymerizable compound means a compound having two or more polymerizable groups, i.e., polymerizable sites. The polyfunctional polymerizable compounds are not particularly limited as long as the polyfunctional polymerizable compounds can be polymerized by heating or irradiation with non-ionizing radiation or ionizing radiation or infrared radiation, and examples of the polyfunctional polymerizable compounds include acrylate resins, methacrylate resins, urethane acrylate resins, vinyl ester resins, unsaturated polyesters, epoxy resins, oxetane resins, vinyl ethers, resins utilizing ene-thiol reactions, and the like. Among these, acrylate resins, methacrylate resins, urethane acrylate resins, and vinyl ester resins are preferable from the viewpoint of productivity.

Further, polymer particles may also be used as a binder to prevent an increase in the viscosity of the liquid composition. In this case, the polymer particles are to have a maximum particle size that is smaller than the nozzle diameter of the inkjet head, and it is preferable that the average particle size is 0.01 μm or more and 1 μm or less.

Examples of the material forming the polymer particles include thermoplastic resins such as polyvinylidene fluoride, acrylic resin, styrene-butadiene copolymer, polyethylene, polypropylene, polyurethane, nylon, polytetrafluoroethylene, polyphenylene sulfide, polyethylene tephthalate, polybutylene tephthalate, and the like.

### —Separator

A separator is provided between the positive electrode and the negative electrode according to need, in order to prevent short-circuiting of the positive electrode and the negative electrode.

Examples of the separator include paper such as kraft paper, vinylon mixed paper, synthetic pulp mixed paper, polyolefin non-woven fabric such as cellophane, polyethylene graft film, polypropylene meltblown non-woven fabric, polyamide non-woven fabric, glass fiber non-woven fabric, micropore film, and the like.

The size of the separator is not particularly limited as long as the separator is of a size that can be used in the electrochemical element, and may be appropriately selected depending on the purpose. The structure of the separator may be a single layer structure or a laminated structure.

### —Electrolyte Solution

As the electrolytic solution, an aqueous electrolytic solution or a non-aqueous electrolytic solution may be used depending on the electrode material. In the aqueous electrolyte solution, examples of the electrolyte salt are sodium hydroxide, potassium hydroxide, sodium chloride, potassium chloride, ammonium chloride, zinc chloride, zinc acetate, zinc bromide, zinc iodide, zinc tartrate, zinc perchlorate, and the like. These may be used alone or two or more kinds may be used in combination.

The non-aqueous solvent is preferably an aprotic organic solvent. In particular, an ether compound, an ester compound, an ester-based organic solvent such as a cyclic ester, a chain-like ester, an ether-based organic solvent such as a cyclic ether, a chain-like ether, or a carbonate-based organic solvent such as a cyclic carbonate, a chain-like carbonate, and the like may be used.

Examples of cyclic esters include γ-butyrolactone (yBL), 2-methyl-γ-butyrolactone, acetyl-γ-butyrolactone, γ-valerolactone, and the like.

Examples of the chain ester include alkyl ester propionate, dialkyl ester malonate, alkyl ester acetate (methyl acetate (MA), ethyl acetate, etc.), alkyl ester formate (methyl formate (MF), ethyl formate, etc.), and the like.

Examples of cyclic ethers include tetrahydrofuran, alkyltetrahydrofuran, alkoxytetrahydrofuran, dialkoxytetrahydrofuran, 1,3-dioxolane, alkyl-1,3-dioxolane, 1,4-dioxolane, and the like.

Examples of chain-like ethers include 1,2-dimethociquiethane (DME), diethyl ether, ethylene glycol dialkyl ether, diethylene glycol dialkyl ether, triethylene glycol dialkyl ether, tetraethylene glycol dialkyl ether, and the like.

Examples of the cyclic carbonate include propylene carbonate (PC), ethylene carbonate (EC), butylene carbonate (BC), vinylene carbonate (VC), and fluoroethylene carbonate (FEC). Chain carbonates which can be added to ethyl methyl carbonate (EMC) include dimethyl carbonate (DMC), diethyl carbonate (DEC) methyl propionate (MP), and the like.

As for the electrolyte salt, there is no particular limitation as long as the electrolyte salt dissolves in a non-aqueous solvent, and the ionized cation indicates high ionic conductivity. Examples of the cations forming the electrolyte salt include alkali metal ions, alkaline earth metal ions, tetraalkyl ammonium ions, spiro-based quaternary ammonium ions, and the like.

Examples of the anions forming the electrolyte salt include Cll⁻, Br⁻, I⁻, ClO₄⁻, BF₄⁻, PF₆⁻, SbF₆⁻, AsF₆⁻, CF₃SO₃⁻, (CF₃SO₂)₂N⁻, (C₂F₅SO₂)₂N⁻, and the like.

Electrolyte salts may be used alone or two or more kinds may be used in combination. The lithium salts are not particularly limited and may be appropriately selected depending on the purpose; examples are lithium hexafluorophosphate (LiPF₆), lithium perchlorate (LiClO₄), lithium chloride (LiCl), lithium borofluoride (LiBF₄), lithium hexafluoride (LiAsF₆), lithium trifluorometasulfonate (LiCF₃SO₃), lithium bis trifluoromethylsulfonyl imide (LiN (C₂F₅SO₂)₂), lithium bis(perfluoroethylsulfonyl)imide (LiN(CF₂F₅SO₂)₂), and the like.

Further, a solid electrolyte may be used instead of the electrolyte solution. When a solid electrolyte is used, a separator is not required.

The electrochemical element can be used in an electrical energy utilizing apparatus. An electrical energy utilizing apparatus means an apparatus that is electrically connected to the electrochemical element and utilizes the electrical energy stored in the electrochemical element.

An electrical energy utilizing apparatus includes, but not limited to, for example, a notebook personal computer (PC), a pen input PC, a mobile PC, an electronic book player, a mobile phone, a portable fax machine, a portable copier, a portable printer, a headphone stereo, a video movie, a liquid crystal television, a portable cleaner, a portable compact disk (CD), a mini disk, a transceiver, an electronic pocketbook, a calculator, a memory card, a portable tape recorder, a radio, a backup power supply, a motor, a lighting fixture, a toy, a game machine, a watch, a strobe, a camera, and the like.

### <Method of Manufacturing Electrochemical Element>

### —Fabrication of Negative Electrode and Positive Electrode

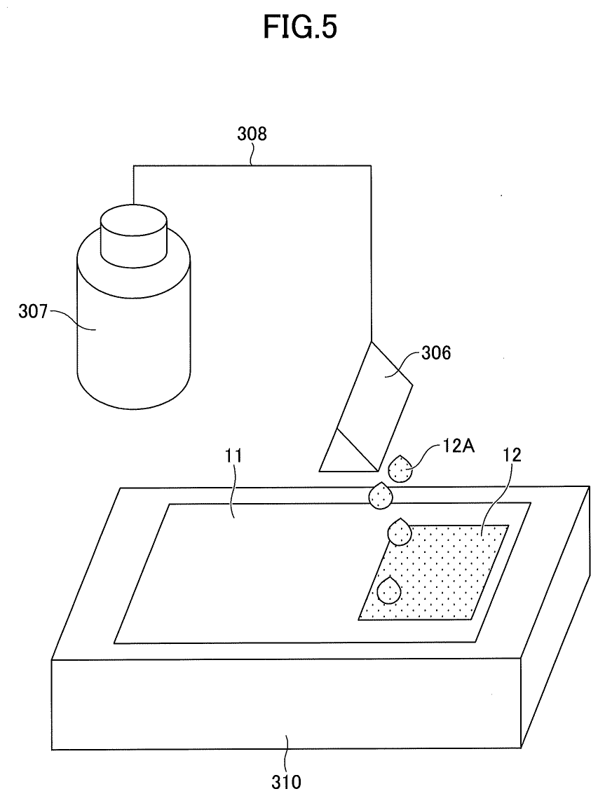

FIG. 5 is a diagram illustrating an example of a method of manufacturing the negative electrode according to the present embodiment, and is an example of manufacturing the negative electrode 10 illustrated in FIG. 1. The method of manufacturing the negative electrode 10 according to the present embodiment includes a step of discharging a liquid composition according to the present embodiment onto the negative electrode substrate 11 using an inkjet method.

First, a liquid composition 12A is fabricated for forming the negative electrode mixture layer 12 including a dispersion medium, a negative electrode material, and a binder, and according to need, a conduction assisting agent and an electrode material dispersant. Next, the liquid composition 12A is stored in a tank 307 to be in a state ready to be supplied from the tank 307 to a liquid discharge mechanism 306 via a tube 308. The liquid discharge mechanism 306, the tank 307, and the tube 308 to be used are resistant to the solvent to be used.

The diameter of the portion at which the liquid composition 12A passes in the liquid discharge mechanism 306, the tank 307, and the tube 308 is to be greater than the maximum particle size of the various electrode materials in the liquid composition 12A. When the diameter of the portion at which the liquid composition 12A passes in the liquid discharge mechanism 306, the tank 307, and the tube 308 is larger than the maximum particle size of various electrode materials of the liquid composition 12A, it is possible to prevent clogging in the liquid discharge mechanism 306, the tank 307, and the tube 308, caused by the electrode materials in the liquid composition 12A, and the discharge stability is improved.

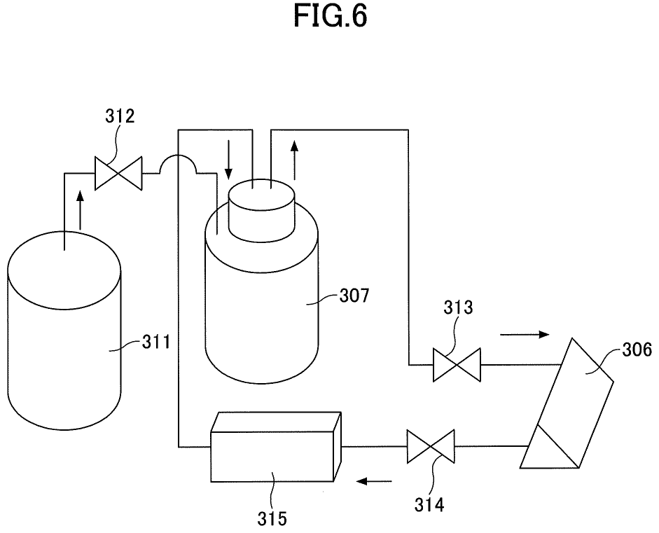

As illustrated in FIG. 6, a mechanism in which the liquid composition 12A circulates in a liquid discharge apparatus may be used. In FIG. 6, an external tank 311 is connected to the tank 307 via a valve 312 and the tank 307 is connected to the liquid discharge mechanism 306 via a valve 313. Further, the liquid discharge mechanism 306 is connected to a pump 315 via a valve 314 and the pump 315 is connected to the tank 307.

In FIG. 6, by controlling the flow of the liquid composition 12A using the pump 315 and the valves 313 and 314, the liquid composition 12A stored in the tank 307 is caused to circulate within the liquid discharge apparatus. By the configuration illustrated in FIG. 6, it is possible to prevent the sedimentation of particles. Further, by providing the external tank 311 and controlling the valve 312, when the amount of the liquid composition 12A that can be discharged is reduced, it is possible to supply the liquid composition 12A from the external tank 311 to the tank 307 of the liquid discharge apparatus.

A mechanism may be provided to cap the nozzle of the liquid discharge mechanism 306 to prevent drying and the like when the liquid composition 12A is not discharged from the liquid discharge mechanism 306. By such a configuration, it is possible to prevent a decrease in the discharging performance caused by the drying of the nozzle.

In order to fabricate the negative electrode 10, as illustrated in FIG. 5, the negative electrode substrate 11 is placed on a stage 310 that can be heated and the liquid composition 12A is discharged to the negative electrode substrate 11. At this time, the stage 310 may move or the liquid discharge mechanism 306 may move.

The liquid composition 12A is discharged from the liquid discharge mechanism 306 onto the negative electrode substrate 11 placed on the stage 310, and is heated by the stage 310 to dry, to form the negative electrode mixture layer 12. The drying process is not limited to heating on the stage 310, and a drying mechanism provided separately from the stage 310 may be used.

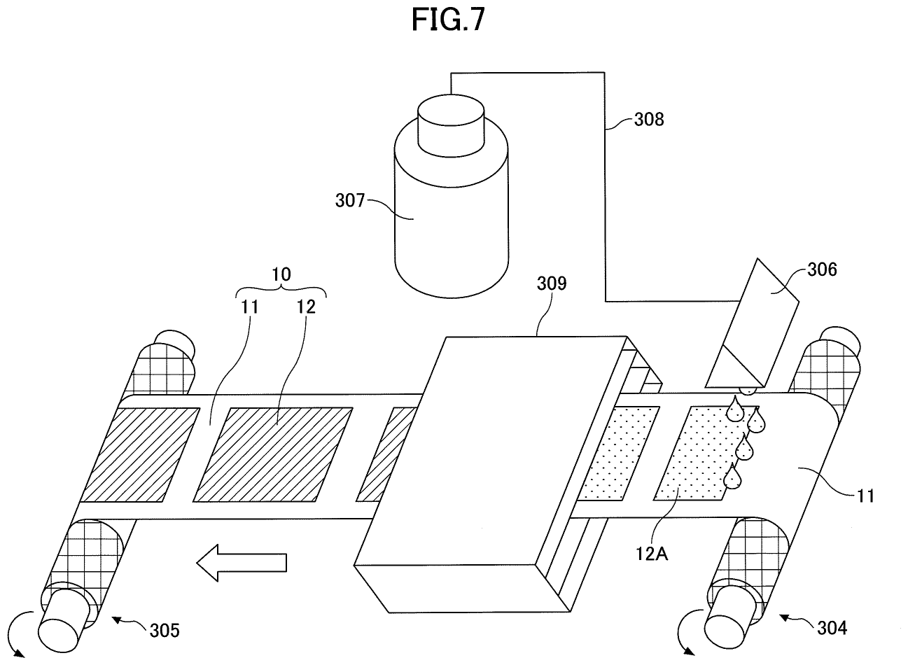

As for the drying mechanism, there is no particular limitation as long as the mechanism is not in direct contact with the liquid composition 12A, and the drying mechanism may be appropriately selected. Examples include a resistive heater, an infrared heater, a fan heater, a blower, and the like. A plurality of drying mechanisms 309 (see FIG. 7) may be provided. The drying temperature is to be lower than the melting temperature of the binder used, preferably in the range of 70° C. to 150° C. in view of power consumption. Further, a device for emitting ultraviolet light may be provided in the drying mechanism.

Further, the negative electrode 10 can be fabricated by using the apparatus illustrated in FIG. 7. FIG. 7 is a diagram illustrating an example of another method of manufacturing the negative electrode according to the present embodiment, and is an example of fabricating the negative electrode 10 illustrated in FIG. 1. As illustrated in FIG. 7, first, the negative electrode substrate 11 having an elongated shape made of stainless steel, copper, and the like is prepared. Next, the negative electrode substrate 11 is wound around a cylindrical core and is set to a feed roller 304 and a reel roller 305 so that the side on which the negative electrode mixture layer 12 is to be formed is on the upper side. Here, the feed roller 304 and the reel roller 305 rotate in a counterclockwise direction, and the negative electrode substrate 11 is conveyed in a right to left direction.

Next, the liquid composition 12A for the negative electrode mixture layer 12 is fabricated, the liquid composition 12A including a dispersion medium, a negative electrode material, and a binder, and according to need, a conduction assisting agent and an electrode material dispersant are added. The fabricated liquid composition 12A is stored in the tank 307 so that the liquid composition 12A can be supplied to the liquid discharge mechanism 306 via the tube 308.

The liquid discharge mechanism 306, the tank 307, and the tube 308 to be used are resistant to the solvent to be used. Further, the liquid discharge mechanism 306, the tank 307, and the tube 308 may be a mechanism by which the liquid composition circulates through the liquid discharge apparatus, as illustrated in FIG. 6.

The liquid discharge mechanism 306 is provided above the negative electrode substrate 11 between the feed roller 304 and the reel roller 305.

Next, the liquid composition 12A is discharged from the liquid discharge mechanism 306 onto the negative electrode substrate 11. The liquid composition 12A is discharged to cover at least a portion of the negative electrode substrate 11. Note that a plurality of the liquid discharge mechanisms 306 may be disposed in a direction substantially parallel to or in a direction substantially perpendicular to the conveying direction of the negative electrode substrate 11.

Next, the negative electrode substrate 11, which is partially covered with the liquid composition 12A, is conveyed to the drying mechanism 309 by the feed roller 304 and the reel roller 305. The drying mechanism 309 dries the liquid composition 12A on the negative electrode substrate 11, thereby forming the negative electrode mixture layer 12, and the negative electrode 10, in which the negative electrode mixture layer 12 is bound to the negative electrode substrate 11, is formed. Subsequently, the negative electrode 10 is cut to a desired size by a punching process and the like.

The drying mechanism 309 is not particularly limited and may be appropriately selected, as long as the mechanism is not in direct contact with the liquid composition 12A. Examples include a resistive heater, an infrared heater, a fan heater, a blower, and the like. The drying mechanism 309 may be provided on either one of the top and bottom of an electrode substrate 301 or may be provided on both the top and bottom of the electrode substrate 301. Further, a plurality of the drying mechanisms 309 may also be provided. The drying temperature is to be lower than the melting temperature of the binder used, preferably in the range of 70° C. to 150° C. in view of power consumption. Further, a device for emitting ultraviolet light may be provided in the drying mechanism.

The inkjet method is suitable in that the target object can be applied to a desired portion of the underlying layer. Further, the inkjet method is suitable for binding the vertically contacting surfaces of the negative electrode substrate 11 and the negative electrode mixture layer 12. Further, the inkjet method is suitable in that the film thickness of the negative electrode mixture layer 12 can be made uniform.

Note that in order to fabricate the negative electrode 15 illustrated in FIG. 3, the negative electrode mixture layer 12 is to be formed on the opposite side of the negative electrode substrate 11 by the same method as that described above.

Further, in order to fabricate the positive electrode 20 illustrated in FIG. 2, the positive electrode substrate 21 is to be used instead of the negative electrode substrate 11 described above, and a liquid composition for the positive electrode mixture layer 22 is to be used instead of the liquid composition 12A for the negative electrode mixture layer 12. Further, in order to fabricate the positive electrode 25 illustrated in FIG. 3, the positive electrode mixture layer 22 is to be formed on the opposite side of the positive electrode substrate 21 by the same method as described above.

### —Fabrication of Electrode Element and Electrochemical Element

In order to fabricate the electrode element 40 and the electrochemical element 1, first, the positive electrode 25 is disposed on one side of the negative electrode 15 such that the negative electrode mixture layer 12 on one side of the negative electrode 15 and the positive electrode mixture layer 22 of the positive electrode 25 face each other via the separator 30. Similarly, the positive electrode 25 is disposed on the other side of the negative electrode 15 such that the negative electrode mixture layer 12 on the other side of the negative electrode 15 and the positive electrode mixture layer 22 on the positive electrode 25 face each other.

Next, the electrode element 40 illustrated in FIG. 3 can be fabricated by bonding the negative electrode extraction line 41 to the negative electrode substrate 11 by welding and the like and bonding the positive electrode extraction line 42 to the positive electrode substrate 21 by welding and the like. Next, the electrolyte layer 51 is formed by injecting the aqueous electrolyte solution or the non-aqueous electrolyte solution into the electrode element 40, and sealing this with the outer sheath 52, thereby fabricating the electrochemical element 1 illustrated in FIG. 4.

Note that as described above, the number of stacked layers of the negative electrode 15 and the positive electrode 25 in the electrode element 40 can be determined to be any number. That is, in FIGS. 3 and 4, a total of three layers of one negative electrode 15 and two positive electrodes 25 are illustrated; however, the number of stacked layers is not limited thereto, and many more negative electrodes 15 and positive electrodes 25 may be stacked.

Thus, in an electrochemical element according to the present embodiment, at least one of the negative electrode mixture layer of the negative electrode and the positive electrode mixture layer of the positive electrode layer is formed of a liquid composition including a dispersion medium, electrode materials, and a compound as a binder capable of binding the electrode material and of binding the electrode material to the electrode substrate, the liquid composition having a viscosity by which the liquid composition can be discharged from an inkjet head.

This liquid composition uses a compound as a binder that prevents an increase in the viscosity of the liquid composition, and, therefore, the viscosity of the liquid composition can be reduced even when the amount of the binder or the electrode materials is increased. Accordingly, even when the content of the electrode material is high, a liquid composition with stable storage properties and stable discharge properties can be obtained.

By using a liquid composition with stable storage properties and stable discharge properties, the negative electrode mixture layer of the negative electrode and/or the positive electrode mixture layer of the positive electrode can be easily formed by the inkjet method, and an electrochemical element, including a large amount of electrode materials and having excellent battery characteristics, can be realized.

Hereinafter, the electrochemical element, etc., will be described in more detail with reference to practical examples and comparative examples. However, the present invention is not limited to these practical examples.

Before the practical examples and comparative examples, first, the granularity distribution of the positive electrode material or the negative electrode material and the viscosity of the liquid composition for the electrode mixture layer were measured by the following method.

### [Granularity Distribution of Positive Electrode Material or Negative Electrode Material]

The granularity distribution of the positive electrode material or the negative electrode material at 25° C. was measured by dispersing the material in water or an organic dispersion medium by using a laser diffraction type granularity distribution measuring device (Master Sizer 3000 manufactured by Malvern Panalytical Ltd).

### [Viscosity of Liquid Composition for Electrode Mixture Layer]

A rotor of No. CPA-40Z was installed in a B-type viscometer (cone plate viscometer) to measure the viscosity at 100 rpm of the liquid composition for the electrode mixture layer at 25° C.

### [Non-Aqueous Electrolyte Solution 100]

20 mL of a non-aqueous electrolyte solution 100 was prepared by dissolving 1.0 mol/L of LiPF₆ in a solvent that is a mixture of propylene-ethylene carbonate (PC)/diethyl carbonate (DEC)/ethylmethyl carbonate (EMC) with a weight ratio of 1:1:1.

### [Aqueous Electrolyte Solution 200]

20 mL of an aqueous electrolyte solution 200 prepared by dissolving 1.0 mol/L of ZnCl₂ of in pure water.

### Practical Example 1

10 g of manganese dioxide, 40 g of N-methylpyrrolidone (NMP, manufactured by FUJIFILM Wako Pure Chemical Co., Ltd.), and 50 g of zirconia balls having a diameter of 0.2 mm were added to a zirconia container, and pulverization was carried out by using the rotation/revolution nano-pulverizing machine NP-100 manufactured by THINKY CORPORATION. After performing 20 cycles of pulverization, each cycle including 1 minute at 1000 rpm and then 1 minute at 400 rpm, the particle size was measured with a granularity distribution meter, and the peak of the granularity distribution was 1.56 μm.

After removing the zirconia balls, the liquid composition was fabricated by adding 10 g of propylene glycol, 0.32 g of carbon black, 0.1 g of pentaerythritol tetra-acrylate (manufactured by Tokyo Chemical Industry Co., Ltd.), 0.2 g of hexamethylene diamine (manufactured by Tokyo Chemical Industry Co., Ltd.), and diazabicycloundecene (DBU, manufactured by Tokyo Chemical Industry Co., Ltd.) as a catalyst. The viscosity of the liquid composition was 12.6 mPa·s. After 24 hours, the granularity distribution of the liquid composition was recalculated, and there was no change in the granularity distribution, and the storage stability of the liquid composition was good.

The liquid composition was printed on aluminum foil to be the positive electrode substrate by using an inkjet printing apparatus EV2500 (manufactured by Ricoh Co., Ltd.). The aluminum foil was fixed on a hot plate and heated to 120° C. The discharge stability of the liquid composition during printing was good, and no discharge failures occurred. As a result, it was possible to form a coating film corresponding to a positive electrode mixture layer having an active material amount of 1.91 mg/cm² per unit area, and the liquid composition for the positive electrode mixture layer had good printing efficiency.

The printed electrode was punched into a round shape with a diameter of 16 mm to form a positive electrode A. The positive electrode A, a separator (glass separator, manufactured by Advantec Toyo Kaisha, Ltd., 100 μm), the non-aqueous electrolyte solution 100, and lithium (manufactured by Honjo Metal Co., Ltd., 200 μm thick) as a counter electrode were placed in a coin can to fabricate a non-aqueous electrolyte primary battery. The resulting battery was discharged to a final voltage of 1.5 V at a constant current of 0.05 mA/cm² at room temperature (25° C.). The capacity per unit area of the positive electrode A was 0.252 mAh/cm². The capacity per unit area of the positive electrode was measured using a charge and discharge measuring device (TOSCAT3001, manufactured by Toyo System Co., Ltd.) (the same applies to other practical examples).

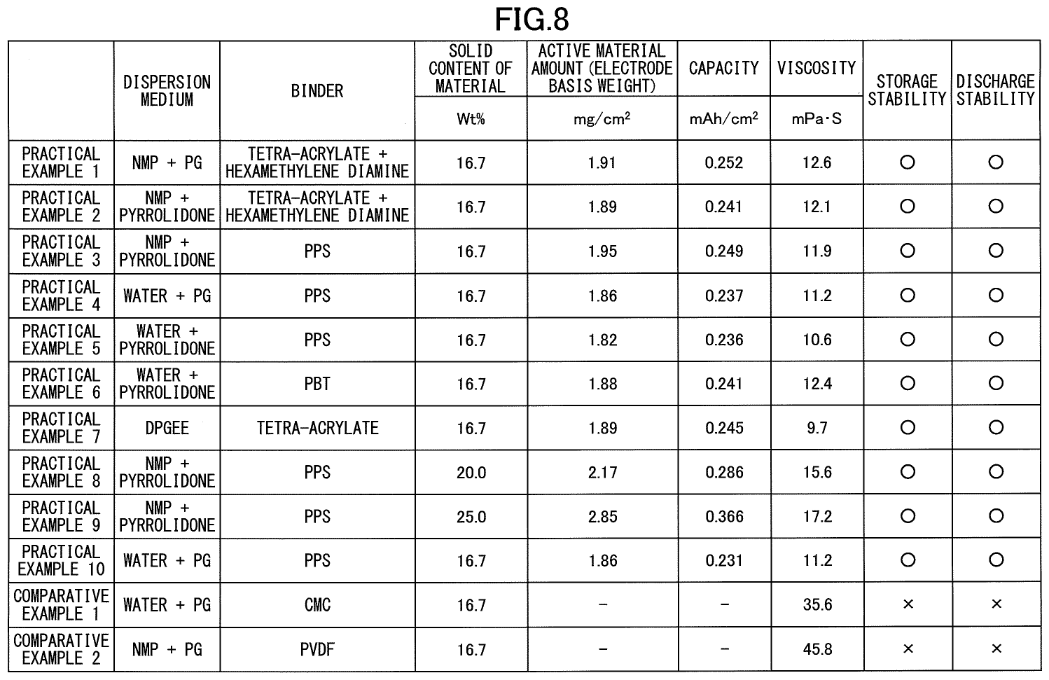

Note that in practical example 1, N-methylpyrrolidone (NMP) and propylene glycol (PG) are dispersion media. Further, in practical example 1, pentaerythritol tetraacrylate and hexamethylenediamine are binders. Further, in practical example 1, the solid content of the material is 16.7 wt %. The results of practical example 1 are summarized in FIG. 8.

Note that in FIG. 8, the storage stability is indicated as “◯)” (good) when there is no change in the granularity distribution of the liquid composition at the time of fabricating the liquid composition and 24 hours after fabrication, and the storage stability is indicated as “x” (poor) when there is a change in the granularity distribution. Further, when the liquid composition is printed on aluminum foil using the inkjet printing apparatus EV2500, the discharge stability is indicated as “◯” (good) when there is no discharge failure, and the discharge stability is indicated as “x” (poor) when there is a discharge failure.

### Practical Example 2

10 g of manganese dioxide, 40 g of N-methylpyrrolidone (NMP, manufactured by FUJIFILM Wako Pure Chemical Co., Ltd.), and 50 g of zirconia balls having a diameter of 0.2 mm were added to a zirconia container, and pulverization was carried out by using the rotation/revolution nano-pulverizing machine NP-100 manufactured by THINKY CORPORATION. After performing 20 cycles of pulverization, each cycle including 1 minute at 1000 rpm and then 1 minute at 400 rpm, the particle size was measured with a granularity distribution meter, and the peak of the granularity distribution was 1.57 μm.

After removing the zirconia balls, a liquid composition was fabricated by adding 10 g of 2-pyrrolidone, 0.32 g of carbon black, 0.1 g of pentaerythritol tetraacrylate, and 0.2 g of hexamethylenediamine and diazabicycloundecene as a catalyst. The viscosity of the liquid composition was 12.1 mPa·s. After 24 hours, the granularity distribution of the liquid composition was recalculated, and there was no change in the granularity distribution, and the storage stability of the liquid composition was good.

The liquid composition was printed on aluminum foil to be the positive electrode substrate by using an inkjet printing apparatus EV2500. The aluminum foil was fixed on a hot plate and heated to 120° C. The discharge stability of the liquid composition during printing was good, and no discharge failures occurred. As a result, it was possible to form a coating film corresponding to a positive electrode mixture layer having an active material amount of 1.89 mg/cm² per unit area, and the liquid composition for the positive electrode mixture layer had good printing efficiency.

The printed electrode was punched into a round shape with a diameter of 16 mm to form a positive electrode B. The positive electrode B, a separator (glass separator, manufactured by Advantec Toyo Kaisha, Ltd., 100 μm), the non-aqueous electrolyte solution 100, and lithium (manufactured by Honjo Metal Co., Ltd., 200 μm thick) as a counter electrode were placed in a coin can to fabricate a non-aqueous electrolyte primary battery. The resulting battery was discharged to a final voltage of 1.5 V at a constant current of 0.05 mA/cm² at room temperature (25° C.). The capacity per unit area of the positive electrode B was 0.241 mAh/cm².

Note that in practical example 2, N-methylpyrrolidone (NMP) and 2-pyrrolidone are dispersion media. Further, in practical example 2, pentaerythritol tetraacrylate and hexamethylenediamine are binders. Further, in practical example 2, the solid content of the material is 16.7 wt %. The results of practical example 2 are summarized in FIG. 8.

### Practical Example 3

10 g of manganese dioxide, 40 g of N-methylpyrrolidone (NMP, manufactured by FUJIFILM Wako Pure Chemical Co., Ltd.), and 50 g of zirconia balls having a diameter of 0.2 mm were added to a zirconia container, and pulverization was carried out by using the rotation/revolution nano-pulverizing machine NP-100 manufactured by THINKY CORPORATION. After performing 20 cycles of pulverization, each cycle including 1 minute at 1000 rpm and then 1 minute at 400 rpm, the particle size was measured with a granularity distribution meter, and the peak of the granularity distribution was 1.55 μm.

After removing the zirconia balls, a liquid composition was fabricated by adding 10 g of 2-pyrrolidone, 0.32 g of carbon black, and 0.32 g of polyphenylene sulfide (PPS) particles (average particle size 0.5 μm). The viscosity of the liquid composition was 11.9 mPa·s. After 24 hours, the granularity distribution of the liquid composition was recalculated, and there was no change in the granularity distribution, and the storage stability of the liquid composition was good.

The liquid composition was printed on aluminum foil to be the positive electrode substrate by using an inkjet printing apparatus EV2500. By the manufacturing method of FIG. 5, the liquid composition was dried at a drying temperature of 120° C. The discharge stability of the liquid composition during printing was good, and no discharge failures occurred. As a result, it was possible to form a coating film corresponding to a positive electrode mixture layer having an active material amount of 1.95 mg/cm² per unit area, and the liquid composition for the positive electrode mixture layer had good printing efficiency.

The printed electrode was punched into a round shape with a diameter of 16 mm to form a positive electrode C. The positive electrode C, a separator (glass separator, manufactured by Advantec Toyo Kaisha, Ltd., 100 μm), the non-aqueous electrolyte solution 100, and lithium (manufactured by Honjo Metal Co., Ltd., 200 μm thick) as a counter electrode were placed in a coin can to fabricate a non-aqueous electrolyte primary battery. The resulting battery was discharged to a final voltage of 1.5 V at a constant current of 0.05 mA/cm² at room temperature (25° C.). The capacity per unit area of the positive electrode C was 0.249 mAh/cm².

Note that in practical example 3, N-methylpyrrolidone (NMP) and 2-pyrrolidone are dispersion media. Further, in practical example 3, the polyphenylene sulfide (PPS) is a binder. Further, in practical example 3, the solid content of the material is 16.7 wt %. The results of practical example 3 are summarized in FIG. 8.

### Practical Example 4

10 g of manganese dioxide, 40 g of pure water, and 50 g of zirconia balls having a diameter of 0.2 mm were added to a zirconia container, and pulverization was carried out by using the rotation/revolution nano-pulverizing machine NP-100 manufactured by THINKY CORPORATION. After performing 20 cycles of pulverization, each cycle including 1 minute at 1000 rpm and then 1 minute at 400 rpm, the particle size was measured with a granularity distribution meter, and the peak of the granularity distribution was 1.51 μm.

After removing the zirconia balls, a liquid composition was fabricated by adding 10 g of propylene glycol, 0.32 g of carbon black, and 0.32 g of polyphenylene sulfide (PPS) particles (average particle size 0.5 μm). The viscosity of the liquid composition was 11.2 mPa·s. After 24 hours, the granularity distribution of the liquid composition was recalculated, and there was no change in the granularity distribution, and the storage stability of the liquid composition was good.

The liquid composition was printed on aluminum foil to be the positive electrode substrate by using an inkjet printing apparatus EV2500. The aluminum foil was fixed on a hot plate and heated to 100° C. The discharge stability of the liquid composition during printing was good, and no discharge failures occurred. As a result, it was possible to form a coating film corresponding to a positive electrode mixture layer having an active material amount of 1.86 mg/cm² per unit area, and the liquid composition for the positive electrode mixture layer had good printing efficiency.

The printed electrode was punched into a round shape with a diameter of 16 mm to form a positive electrode D. The positive electrode D, a separator (glass separator, manufactured by Advantec Toyo Kaisha, Ltd., 100 μm), the non-aqueous electrolyte solution 100, and lithium (manufactured by Honjo Metal Co., Ltd., 200 μm thick) as a counter electrode were placed in the coin can to fabricate a non-aqueous electrolyte primary battery. The resulting battery was discharged to a final voltage of 1.5 V at a constant current of 0.05 mA/cm² at room temperature (25° C.). The capacity per unit area of the positive electrode D was 0.237 mAh/cm².

Note that in practical example 4, pure water and propylene glycol (PG) are dispersion media. Further, in practical example 4, the polyphenylene sulfide (PPS) is a binder. Further, in practical example 4, the solid content of the material is 16.7 wt %. The results of practical example 4 are summarized in FIG. 8.

### Practical Example 5

10 g of manganese dioxide, 30 g of pure water, and 50 g of zirconia balls having a diameter of 0.2 mm were added to a zirconia container, and pulverization was carried out by using the rotation/revolution nano-pulverizing machine NP-100 manufactured by THINKY CORPORATION. After performing 20 cycles of pulverization, each cycle including 1 minute at 1000 rpm and then 1 minute at 400 rpm, the particle size was measured with a granularity distribution meter, and the peak of the granularity distribution was 1.50 μm.

After removing the zirconia balls, a liquid composition was fabricated by adding 0.32 g of carbon black and 0.32 g of polyphenylene sulfide (PPS) particles (average particle size 0.5 μm). The viscosity of the liquid composition was 10.6 mPa·s. After 24 hours, the granularity distribution of the liquid composition was recalculated, and there was no change in the granularity distribution, and the storage stability of the liquid composition was good.

The liquid composition was printed on aluminum foil to be the positive electrode substrate by using an inkjet printing apparatus EV2500. By the manufacturing method of FIG. 5, the liquid composition was dried at a drying temperature of 120° C. The discharge stability of the liquid composition during printing was good, and no discharge failures occurred. As a result, it was possible to form a coating film corresponding to a positive electrode mixture layer having an active material amount of 1.82 mg/cm² per unit area, and the liquid composition for the positive electrode mixture layer had good printing efficiency.

The printed electrode was punched into a round shape with a diameter of 16 mm to form a positive electrode E. The positive electrode E, a separator (glass separator, manufactured by Advantec Toyo Kaisha, Ltd., 100 μm), the non-aqueous electrolyte solution 100, and lithium (manufactured by Honjo Metal Co., Ltd., 200 μm thick) as a counter electrode were placed in a coin can to fabricate a non-aqueous electrolyte primary battery. The resulting battery was discharged to a final voltage of 1.5 V at a constant current of 0.05 mA/cm² at room temperature (25° C.). The capacity per unit area of the positive electrode E was 0.236 mAh/cm².

Note that in practical example 5, the pure water is a dispersion medium. Further, in practical example 5, the polyphenylene sulfide (PPS) is a binder. Further, in practical example 5, the solid content of the material is 16.7 wt %. The results of practical example 5 are summarized in FIG. 8.

### Practical Example 6

10 g of manganese dioxide, 30 g of pure water, and 50 g of zirconia balls having a diameter of 0.2 mm were added to a zirconia container, and pulverization was carried out by using the rotation/revolution nano-pulverizing machine NP-100 manufactured by THINKY CORPORATION. After performing 20 cycles of pulverization, each cycle including 1 minute at 1000 rpm and then 1 minute at 400 rpm, the particle size was measured with a granularity distribution meter, and the peak of the granularity distribution was 1.58 μm.

After removing the zirconia balls, a liquid composition was fabricated by adding 10 g of 2-pyrrolidone, 0.32 g of carbon black, and 0.32 g of polybutylene terephthalate (PBT) particles (average particle size 0.5 μm), and the viscosity of the fabricated liquid composition was 12.4 mPa·s. After 24 hours, the granularity distribution of the liquid composition was recalculated, and there was no change in the granularity distribution, and the storage stability of the liquid composition was good.

The liquid composition was printed on aluminum foil to be the positive electrode substrate by using an inkjet printing apparatus EV2500. The aluminum foil was fixed on a hot plate and heated to 100° C. The discharge stability of the liquid composition during printing was good, and no discharge failures occurred. As a result, it was possible to form a coating film corresponding to a positive electrode mixture layer having an active material amount of 1.88 mg/cm² per unit area, and the liquid composition for the positive electrode mixture layer had good printing efficiency.

The printed electrode was punched into a round shape with a diameter of 16 mm to form a positive electrode F. The positive electrode F, a separator (glass separator, manufactured by Advantec Toyo Kaisha, Ltd., 100 μm), the non-aqueous electrolyte solution 100, and lithium (manufactured by Honjo Metal Co., Ltd., 200 μm thick) as a counter electrode were placed in a coin can to fabricate a non-aqueous electrolyte primary battery. The resulting battery was discharged to a final voltage of 1.5 V at a constant current of 0.05 mA/cm² at room temperature (25° C.). The capacity per unit area of the positive electrode F was 0.241 mAh/cm².

Note that in practical example 6, pure water and 2-pyrrolidone are dispersion media. Further, in practical example 6, polybutylene terephthalate (PBT) is a binder. Further, in practical example 6, the solid content of the material is 16.7 wt %. The results of practical example 6 are summarized in FIG. 8.

### Practical Example 7

10 g of manganese dioxide, 40 g of propylene glycol monomethyl ether (DPGEE, manufactured by Tokyo Chemical Industry Co., Ltd.), and 50 g of zirconia balls having a diameter of 0.2 mm were added to a zirconia container, and pulverization was carried out by using the rotation/revolution nano-pulverizing machine NP-100 manufactured by THINKY CORPORATION. After performing 20 cycles of pulverization, each cycle including 1 minute at 1000 rpm and then 1 minute at 400 rpm, the particle size was measured with a granularity distribution meter, and the peak of the granularity distribution was 1.56 μm.

After removing the zirconia balls, a liquid composition was fabricated by adding 10 g of propylene glycol monomethyl ether, 0.32 g of carbon black, 0.3 g of pentaerythritol tetraacrylate, and V-(2,2′-azobis (2,4-dimethylvaleronitrile, manufactured by FUJIFILM Wako Pure Chemical Co., Ltd.) as a reaction starting material. The viscosity of the liquid composition was 9.7 mPa's. After 24 hours, the granularity distribution of the liquid composition was recalculated, and there was no change in the granularity distribution, and the storage stability of the liquid composition was good.

The liquid composition was printed on aluminum foil to be the positive electrode substrate by using an inkjet printing apparatus EV2500. The aluminum foil was fixed on a hot plate and heated to 110° C. The discharge stability of the liquid composition during printing was good, and no discharge failures occurred. As a result, it was possible to form a coating film corresponding to a positive electrode mixture layer having an active material amount of 1.89 mg/cm² per unit area, and the liquid composition for the positive electrode mixture layer had good printing efficiency.

The printed electrode was punched into a round shape with a diameter of 16 mm to form a positive electrode G. The positive electrode G, a separator (glass separator, manufactured by Advantec Toyo Kaisha, Ltd., 100 μm), the non-aqueous electrolyte solution 100, and lithium (manufactured by Honjo Metal Co., Ltd., 200 μm thick) as a counter electrode were placed in a coin can to fabricate a non-aqueous electrolyte primary battery. The resulting battery was discharged to a final voltage of 1.5 V at a constant current of 0.05 mA/cm² at room temperature (25° C.). The capacity per unit area of the positive electrode G was 0.245 mAh/cm².

Note that in practical example 7, the propylene glycol monomethyl ether (DPGEE) is a dispersion medium. Further, in practical example 7, the pentaerythritol tetra-acrylate is a binder. Further, in practical example 7, the solid content of the material is 16.7 wt %. The results of practical example 7 are summarized in FIG. 8.

### Practical Example 8

10 g of manganese dioxide, 32 g of N-methylpyrrolidone (NMP, manufactured by FUJIFILM Wako Pure Chemical Co., Ltd.), and 50 g of zirconia balls having a diameter of 0.2 mm were added to a zirconia container, and pulverization was carried out by using the rotation/revolution nano-pulverizing machine NP-100 manufactured by THINKY CORPORATION. After performing 20 cycles of pulverization, each cycle including 1 minute at 1000 rpm and then 1 minute at 400 rpm, the particle size was measured with a granularity distribution meter, and the peak of the granularity distribution was 1.42 μm.

After removing the zirconia balls, a liquid composition was fabricated by adding 8 g of 2-pyrrolidone, 0.32 g of carbon black, and 0.32 g of polyphenylene sulfide (PPS) particles (average particle size 0.5 μm). The viscosity of the liquid composition was 15.6 mPa·s. After 24 hours, the granularity distribution of the liquid composition was recalculated, and there was no change in the granularity distribution, and the storage stability of the liquid composition was good.

The liquid composition was printed on aluminum foil to be the positive electrode substrate by using an inkjet printing apparatus EV2500. The aluminum foil was fixed on a hot plate and heated to 120° C. The discharge stability of the liquid composition during printing was good, and no discharge failures occurred. As a result, it was possible to form a coating film corresponding to a positive electrode mixture layer having an active material amount of 2.17 mg/cm² per unit area, and the liquid composition for the positive electrode mixture layer had good printing efficiency.

The printed electrode was punched into a round shape with a diameter of 16 mm to obtain a positive electrode H. The positive electrode H, a separator (glass separator, manufactured by Advantec Toyo Kaisha, Ltd., 100 μm), the non-aqueous electrolyte solution 100, and lithium (manufactured by Honjo Metal Co., Ltd., 200 μm thick) as a counter electrode were placed in a coin can to fabricate a non-aqueous electrolyte primary battery. The resulting battery was discharged to a final voltage of 1.5 V at a constant current of 0.05 mA/cm² at room temperature (25° C.). The capacity per unit area of the positive electrode H was 0.286 mAh/cm².

Note that in practical example 8, N-methylpyrrolidone (NMP) and 2-pyrrolidone are dispersion media. Further, in practical example 8, the polyphenylene sulfide (PPS) is a binder. Further, in practical example 8, the solid content of the material is 20.0 wt %. The results of practical example 8 are summarized in FIG. 8.

### Practical Example 9

10 g of manganese dioxide, 24 g of N-methylpyrrolidone (NMP, manufactured by FUJIFILM Wako Pure Chemical Co., Ltd.), and 50 g of zirconia balls having a diameter of 0.2 mm were added to a zirconia container, and pulverization was carried out by using the rotation/revolution nano-pulverizing machine NP-100 manufactured by THINKY CORPORATION. After performing 20 cycles of pulverization, each cycle including 1 minute at 1000 rpm and then 1 minute at 400 rpm, the particle size was measured with a granularity distribution meter, and the peak of the granularity distribution was 1.42 μm.

After removing the zirconia balls, a liquid composition was fabricated by adding 6 g of 2-pyrrolidone, 0.32 g of carbon black, and 0.32 g of polyphenylene sulfide (PPS) particles (average particle size 0.5 μm). The viscosity of the liquid composition was 17.2 mPa·s. After 24 hours, the granularity distribution of the liquid composition was recalculated, and there was no change in the granularity distribution, and the storage stability of the liquid composition was good.

The liquid composition was printed on aluminum foil to be the positive electrode substrate by using an inkjet printing apparatus EV2500. The aluminum foil was fixed on a hot plate and heated to 100° C. The discharge stability of the liquid composition during printing was good, and no discharge failures occurred. As a result, it was possible to form a coating film corresponding to a positive electrode mixture layer having an active material amount of 2.85 mg/cm² per unit area, and the liquid composition for the positive electrode mixture layer had good printing efficiency.

The printed electrode was punched into a round shape with a diameter of 16 mm to form a positive electrode I. The positive electrode I, a separator (glass separator, manufactured by Advantec Toyo Kaisha, Ltd., 100 μm), the non-aqueous electrolyte solution 100, and lithium (manufactured by Honjo Metal Co., Ltd., 200 μm thick) as a counter electrode were placed in a coin can to fabricate a non-aqueous electrolyte primary battery. The resulting battery was discharged to a final voltage of 1.5 V at a constant current of 0.05 mA/cm² at room temperature (25° C.). The capacity per unit area of the positive electrode I was 0.366 mAh/cm².

Note that in practical example 9, N-methylpyrrolidone (NMP) and 2-pyrrolidone are dispersion media. Further, in practical example 9, the polyphenylene sulfide (PPS) is a binder. Further, in practical example 9, the solid content of the material is 25.0 wt %. The results of practical example 9 are summarized in FIG. 8.

### Practical Example 10

A positive electrode D was prepared in the same manner as in practical example 4. The positive electrode D, a separator (glass separator, manufactured by Advantec Toyo Kaisha, Ltd., 100 μm), the aqueous electrolyte solution 200, and a zinc plate of 99.9% as a counter electrode were placed in the coin can to fabricate an aqueous electrolyte primary battery. The resulting battery was discharged to a final voltage of 0.3 V at a constant current of 0.05 mA/cm² at room temperature (25° C.). The capacity per unit area of the positive electrode D was 0.231 mAh/cm².

Note that in practical example 10, pure water and propylene glycol (PG) are dispersion media. Further, in practical example 10, the polyphenylene sulfide (PPS) is a binder. Further, in practical example 10, the solid content of the material is 16.7 wt %. The results of practical example 10 are summarized in FIG. 8.

### Comparative Example 1

10 g of manganese dioxide, 40 g of pure water, and 50 g of zirconia balls having a diameter of 0.2 mm were added to a zirconia container, and pulverization was carried out by using the rotation/revolution nano-pulverizing machine NP-100 manufactured by THINKY CORPORATION. After performing 20 cycles of pulverization, each cycle including 1 minute at 1000 rpm and then 1 minute at 400 rpm, the particle size was measured with a granularity distribution meter, and the peak of the granularity distribution was 1.5 μm.

After removing the zirconia balls, a liquid composition was fabricated by adding 10 g of propylene glycol, 0.32 g of carbon black, and 0.32 g of sodium carboxymethylcellulose (CMC Daicel 1220, manufactured by Daicel Corporation). The viscosity of the liquid composition was 35.6 mPa·s. After 24 hours, the granularity distribution of the liquid composition was recalculated, and the peak height was reduced, a new peak appeared at 15 μm, and d90 was 25 μm. Therefore, the storage stability of the liquid composition for the positive electrode mixture layer was poor.

The liquid composition was printed on aluminum foil to be the positive electrode substrate by using an inkjet printing apparatus EV2500. The aluminum foil was fixed on a hot plate and heated to 120° C. Immediately after the start of printing, discharge failures were observed in some nozzles, and as the printing continued, nozzles with discharge failures continued to increase. Therefore, the discharge stability of the liquid composition for the positive electrode mixture layer was poor. This is considered to be caused by the particle size being larger than the nozzle diameter.

Note that in comparative example 1, pure water and propylene glycol (PG) are dispersion media. Further, in comparative example 1, sodium carboxymethylcellulose (CMC) is a binder. Further, in comparative example 1, the solid content of the material is 16.7 wt %. The results of comparative example 1 are summarized in FIG. 8.

### Comparative Example 2

10 g of manganese dioxide, 40 g of N-methylpyrrolidone, and 50 g of zirconia balls having a diameter of 0.2 mm were added to a zirconia container, and pulverization was carried out by using the rotation/revolution nano-pulverizing machine NP-100 manufactured by THINKY CORPORATION. After performing 20 cycles of pulverization, each cycle including 1 minute at 1000 rpm and then 1 minute at 400 rpm, the particle size was measured with a granularity distribution meter, and the peak of the granularity distribution was 1.5 μm.

After removing the zirconia balls, a liquid composition was fabricated by adding 10 g of propylene glycol, 0.32 g of carbon black, and 0.32 g of polyvinylidene fluoride (PVDF). The viscosity of the liquid composition was 45.8 mPa·s. After 24 hours, the granularity distribution of the liquid composition was recalculated and the peak height was reduced, a new peak appeared at 25 μm, and d90 was 35 μm. Therefore, the storage stability of the liquid composition for the positive electrode mixture layer was poor.

The liquid composition was printed on aluminum foil to be the positive electrode substrate by using an inkjet printing apparatus EV2500. The aluminum foil was fixed on a hot plate and heated to 120° C. Immediately after the start of printing, discharge failures were observed in some nozzles, and as the printing continued, nozzles with discharge failures continued to increase. Therefore, the discharge stability of the liquid composition for the positive electrode mixture layer was poor.

Note that in comparative example 2, N-methylpyrrolidone (NMP) and propylene glycol (PG) are dispersion media. Further, in comparative example 2, polyvinylidene fluoride (PVDF) is a binder. Further, in comparative example 2, the solid content of the material is 16.7 wt %. The results of comparative example 2 are summarized in FIG. 8.

According to one embodiment of the present invention, a liquid composition that has excellent storage stability and discharge stability, and that can be used to form an electrode mixture layer included in an electrochemical element, can be provided.

The liquid composition, the electrode and the method of manufacturing the electrode, and the electrochemical element and the method of manufacturing the electrochemical element are not limited to the specific embodiments described in the detailed description, and variations and modifications may be made without departing from the spirit and scope of the present invention.

What is claimed is:

1. A liquid composition used for forming an electrode mixture layer included in an electrochemical element, the liquid composition comprising:
a dispersion medium;
an electrode material; and
a compound configured to bind the electrode material, and to bind the electrode material to an electrode substrate, wherein
the liquid composition has a viscosity such that the liquid composition can be discharged from an inkjet head.

2. The liquid composition according to claim 1, wherein the viscosity of the liquid composition at 25° C. is the viscosity such that the liquid composition can be discharged from the inkjet head.

3. The liquid composition according to claim 1, wherein the viscosity of the liquid composition at 25° C. is 200 mPa·s or less.

4. The liquid composition according to claim 1, wherein
the liquid composition includes at least one kind of molecule having a polymerizable site, and
the electrode material is bound, and the electrode material is bound to the electrode substrate, by progress of polymerization at 25° C.

5. The liquid composition according to claim 4, wherein
the at least one kind of molecule including the polymerizable site is configured to form a plurality of holes inside the electrode mixture layer, and
one of the plurality of holes inside the electrode mixture layer is in communication with other holes of the plurality of holes surrounding the one of the plurality of holes.

6. The liquid composition according to claim 1, wherein
the compound includes polymer particles, and
a maximum particle size of the polymer particles is smaller than a nozzle diameter of the inkjet head.

7. The liquid composition according to claim 1, wherein the compound has an average particle size of 0.01 μm or more and 1 μm or less.

8. The liquid composition according to claim 1, wherein a content of the electrode material in the liquid composition is 20% by mass or more.

9. The liquid composition according to claim 1, wherein the electrode material has an average particle size of 3 μm or less.

10. An electrode comprising:
the liquid composition according to claim 1; and
the electrode substrate onto which the liquid composition is discharged.

11. The electrochemical element comprising:
the electrode according to claim 10.

12. A method of manufacturing an electrode, the method comprising:
discharging the liquid composition according to claim 1 onto the electrode substrate.

13. A method of manufacturing the electrochemical element, the method comprising:
discharging the liquid composition according to claim 1 onto the electrode substrate.
